(19) United States
(12) Patent Application Publication
(10) Pub. No.: US 2025/0158059 A1
(43) Pub. Date: May 15, 2025

(54) ALL-SOLID-STATE BATTERY HAVING COATING LAYER INCLUDING LAYERED CARBON MATERIAL AND MANUFACTURING METHOD THEREOF

(71) Applicants: HYUNDAI MOTOR COMPANY, Seoul (KR); Kia Corporation, Seoul (KR); Research & Business Foundation SUNGKYUNKWAN UNIVERSITY, Suwon-si (KR)

(72) Inventors: Ki Yoon Bae, Seoul (KR); Ji Young Kim, Suwon-si (KR); Sam Ick Son, Suwon-si (KR); Hyung Mo Jeong, Suwon-si (KR); Woo Hyeong SIM, Suwon-si (KR); Dong Hyoung Kim, Suwon-si (KR)

(73) Assignees: HYUNDAI MOTOR COMPANY, Seoul (KR); Kia Corporation, Seoul (KR); Research & Business Foundation SUNGKYUNKWAN UNIVERSITY, Suwon-si (KR)

(21) Appl. No.: 18/417,795

(22) Filed: Jan. 19, 2024

(30) Foreign Application Priority Data
Nov. 9, 2023 (KR) 10-2023-0154638

(51) Int. Cl. H01M 4/587; H01M 4/02; H01M 4/133; H01M 10/0562

(52) U.S. Cl. CPC H01M 4/587; H01M 4/133; H01M 10/0562; H01M 2004/021; H01M 2300/008

(57) ABSTRACT

An all-solid-state battery having a coating layer includes a layered carbon material and a manufacturing method thereof. The all-solid-state battery has improved life characteristics depending on repetition of a charge and discharge cycle due to case in diffusion of lithium ions into the coating layer during charging.

### CROSS-REFERENCE TO RELATED APPLICATION

The present application claims priority to Korean Patent Application No. 10-2023-0154638 filed on Nov. 9, 2023, the entire contents of which is incorporated herein for all purposes by this reference.

### BACKGROUND OF THE PRESENT DISCLOSURE

### Field of the Present Disclosure

The present disclosure relates to an all-solid-state battery having a coating layer including a layered carbon material and a manufacturing method thereof. More particularly, it relates to an all-solid-state battery having improved life characteristics depending on a charge and discharge cycle due to ease in diffusion of lithium ions into a coating layer during charging, and a manufacturing method thereof.

### Description of Related Art

Lithium ion batteries are widely used in various apparatuses requiring energy storage. They require various battery characteristics, such as a high energy density, long cycle life, rapid charging and discharging, and high-temperature/low-temperature driving performance, depending on the field of application.

Recently, use of fossil fuels is avoided to solve environmental problems caused by carbon dioxide (CO₂), and thus, there is a great interest in electric vehicles using secondary batteries in the vehicle industry. When a currently developed lithium ion battery is used, an electric vehicle may travel about 400 km on a single charge, but problems, such as instability at a high temperature and fires, still exist. To solve these problems, many companies are competitively developing next-generation secondary batteries.

All-solid-state batteries, which are attracting attention as a next-generation secondary battery, include all elements formed of solid, and have advantages, such a low risk of fire and explosion and high mechanical strength, as compared to lithium ion batteries using combustible organic solvents as electrolyte solutions. However, an anode active material layer of the all-solid-state battery is formed by mixing an anode active material and a solid electrolyte configured to ensure ionic conductivity, and the above-described conventional all-solid-state batteries have low energy density compared to the lithium ion batteries because the specific gravity of the solid electrolyte is greater than that of a liquid electrolyte.

To solve such a problem, research on a storage-type anodeless all-solid-state battery, i.e., in which an anode is omitted or a small amount of an anode active material is used and lithium is deposited directly on an anode current collector, is underway. When lithium ions are not stored in graphite but are is deposited in the form of lithium metal on the anode current collector as above, irreversible reaction is gradually increased due to non-uniform deposition of lithium or formation of lithium dendrites, and thus, the life and durability of the anodeless all-solid-state battery are greatly reduced.

The information included in this Background in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an all-solid-state battery which has a coating layer including a carbon material on an anode current collector to suppress non-uniform deposition of lithium and formation of lithium dendrites.

Here, the ratio, diameter, volume and surface area of pores providing a space in which lithium ions are stored in a form of lithium metal may be varied depending on the structure of the carbon material. Therefore, it is an object of the present disclosure to provide an all-solid-state battery which has a coating layer including a carbon material enabling storage of lithium metal during charging and migration of lithium ions to a solid electrolyte during discharging.

Furthermore, the all-solid-state battery includes respective elements formed of solid, and thus, it is more important to control a contact area of an interface between the solid electrolyte and an anode current collector compared to use of a liquid electrolyte. Therefore, a manufacturing process of the all-solid-state battery is accompanied by a process of bonding a cathode, the solid electrolyte and an anode by applying high pressure thereto.

Here, when such pressure applied to conventional all-solid-state batteries is also applied to the all-solid-state battery according to an exemplary embodiment of the present disclosure, electrochemical characteristics of the all-solid-state battery may deteriorate due to contraction of the pores included in the carbon material. Therefore, it is another object of the present disclosure to provide a manufacturing method of an all-solid-state battery including the carbon material, to which the optimum pressing conditions are applied during a pressing process executed to manufacture the all-solid-state battery.

In one aspect, the present disclosure provides an all-solid-state battery including an anode current collector, a coating layer located on the anode current collector and including a layered carbon material, a solid electrolyte layer located on the coating layer, a cathode active material layer located on the solid electrolyte layer and including a cathode active material configured to enable intercalation and deintercalation of lithium ions, and a cathode current collector located on the cathode active material layer, wherein the layered carbon material includes at least one pore.

In an exemplary embodiment of the present disclosure, the layered carbon material may include at least one selected from the group consisting of graphene, graphene oxide, reduced graphene oxide, carbon nanotubes, and combinations thereof.

In another exemplary embodiment of the present disclosure, the lithium ions may be stored in a form of lithium metal in the at least one pore of the coating layer when the all-solid-state battery is charged.

In yet another exemplary embodiment of the present disclosure, an average diameter D50 of the at least one pore may be 30.08 nm to 33.13 nm.

In yet another exemplary embodiment of the present disclosure, a total pore volume of the coating layer may be 0.114 cm³g⁻¹ to 0.141 cm³g⁻¹.

In still yet another exemplary embodiment of the present disclosure, a Brunauer-Emmett-Teller (BET) surface area of the coating layer may be 15.03 m²g⁻¹ to 17.15 m²g⁻¹.

In a further exemplary embodiment of the present disclosure, a difference between a thickness of the coating layer in a charged state of the all-solid-state battery and a thickness of the coating layer in a discharged state of the all-solid-state battery may be 5 μm or more.

In another further exemplary embodiment of the present disclosure, in a charged state of the all-solid-state battery, the coating layer may not include sulfur (S), but may include at least one selected from the group consisting of bromine (Br), chlorine (Cl), iodine (I), and combinations thereof.

In yet another further exemplary embodiment of the present disclosure, an upper portion of the coating layer adjacent to the solid electrolyte layer may include lithium (Li), and at least one selected from the group consisting of bromine (Br), chlorine (Cl), iodine (I), and combinations thereof, and a lower portion of the coating layer adjacent to the anode current collector may include carbon (C), lithium (Li), and at least one selected from the group consisting of bromine (Br), chlorine (Cl), iodine (I), and combinations thereof.

In another aspect, the present disclosure provides a manufacturing method of an all-solid-state battery including preparing a structure configured so that an anode current collector, a coating layer, a solid electrolyte layer, a cathode active material layer and a cathode current collector are sequentially stacked, and applying a process pressure of greater than 50 MPa but less than 200 MPa to the structure, wherein the coating layer includes a layered carbon material including at least one pore.

In an exemplary embodiment of the present disclosure, the layered carbon material may include at least one selected from the group consisting of graphene, graphene oxide, reduced graphene oxide, carbon nanotubes, and combinations thereof.

In another exemplary embodiment of the present disclosure, lithium ions may be stored in a form of lithium metal in the at least one pore of the coating layer when the all-solid-state battery is charged.

In yet another exemplary embodiment of the present disclosure, an average diameter D50 of the at least one pore may be 30.08 nm to 33.13 nm.

In yet another exemplary embodiment of the present disclosure, a total pore volume of the coating layer may be 0.114 cm³g⁻¹ to 0.141 cm³g⁻¹.

In still yet another exemplary embodiment of the present disclosure, a BET surface area of the coating layer may be 15.03 m²g⁻¹ to 17.15 m²g⁻¹.

In a further exemplary embodiment of the present disclosure, a difference between a thickness of the coating layer in a charged state of the all-solid-state battery and a thickness of the coating layer in a discharged state of the all-solid-state battery may be 5 μm or more.

In another further exemplary embodiment of the present disclosure, in a charged state of the all-solid-state battery, the coating layer may not include sulfur (S), but may include at least one selected from the group consisting of bromine (Br), chlorine (Cl), iodine (I), and combinations thereof.

In yet another further exemplary embodiment of the present disclosure, an upper portion of the coating layer adjacent to the solid electrolyte layer may include lithium (Li), and at least one selected from the group consisting of bromine (Br), chlorine (Cl), iodine (I), and combinations thereof, and a lower portion of the coating layer adjacent to the anode current collector may include carbon (C), lithium (Li), and at least one selected from the group consisting of bromine (Br), chlorine (Cl), iodine (I), and combinations thereof.

Other aspects and exemplary embodiments of the present disclosure are discussed infra.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1A shows a cross-sectional view of an all-solid-state battery according to an exemplary embodiment of the present disclosure in a discharged state;

FIG. 1B shows a cross-sectional view of the all-solid-state battery according to an exemplary embodiment of the present disclosure in a charged state;

FIG. 2 shows a scanning electron microscopy (SEM) image of a half-cell manufactured according to an exemplary embodiment of the present disclosure, in a state in which the half-cell is not charged;

FIG. 3A shows a graph of a voltage profile of the half-cell manufactured according to an exemplary embodiment of the present disclosure in the first cycle;

FIG. 3B, FIG. 3C, and FIG. 3D show graphs of voltage profiles of half-cells manufactured according to Comparative Examples 1 to 3 in the first cycle, respectively;

FIG. 4A shows a graph of changes in Coulombic efficiency and capacity of the half-cell manufactured according to an exemplary embodiment of the present disclosure depending on repetition of a charge and discharge cycle;

FIG. 4B and FIG. 4C show graphs of changes in Coulombic efficiencies and capacities of the half-cells manufactured according to Comparative Examples 1 and 2 depending on repetition of the charge and discharge cycle, respectively;

FIG. 5A shows a graph of analysis results of a BET surface area, a total pore volume and an average pore size of a coating layer included in the half-cell manufactured according to an exemplary embodiment of the present disclosure;

FIG. 5B, FIG. 5C, and FIG. 5D show graphs of analysis results of BET surface areas, total pore volumes and average pore sizes of respective coating layers included in the half-cells manufactured according to Comparative Examples 1 to 3, respectively;

FIG. 6 shows a graph of pore distributions of the half-cells according to Example and Comparative Examples;

FIG. 7A, FIG. 7B, FIG. 7C, FIG. 7D, and FIG. 7E show an SEM image and energy-dispersive X-ray spectroscopy (EDS) images of the half-cell manufactured according to Comparative Example 1, respectively;

FIG. 8A, FIG. 8B, FIG. 8C, FIG. 8D and FIG. 8E show an SEM image and EDS images of the half-cell manufactured according to Example 1, respectively;

FIG. 9A, FIG. 9B, FIG. 9C, FIG. 9D and FIG. 9E show an SEM image and EDS images of the half-cell manufactured according to Comparative Example 2, respectively; and

FIG. 10 shows an SEM image of the half-cell manufactured according to Comparative Example 3.

It should be understood that the appended drawings are not necessarily to scale, presenting a somewhat simplified representation of various exemplary features illustrative of the basic principles of the present disclosure. The specific design features of the present disclosure as disclosed herein, including, for example, specific dimensions, orientations, locations, and shapes, will be determined in part by the particular intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The above-described objects, other objects, advantages and features of the present disclosure will become apparent from the descriptions of embodiments provided hereinbelow with reference to the accompanying drawings. However, the present disclosure is not limited to the exemplary embodiments included herein and may be implemented in various different forms. The exemplary embodiments are provided to make the description of the present disclosure thorough and to fully convey the scope of the present disclosure to those skilled in the art.

In the drawings, the same or similar elements are denoted by the same reference numerals even though they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the present disclosure. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. Furthermore, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. Furthermore, it will be understood that, if a numerical range is disclosed in the description, such a range includes all continuous values from a minimum value to a maximum value of the range, unless stated otherwise. Furthermore, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Furthermore, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

### All-Solid-State Battery Having Coating Layer Including Layered Carbon Material

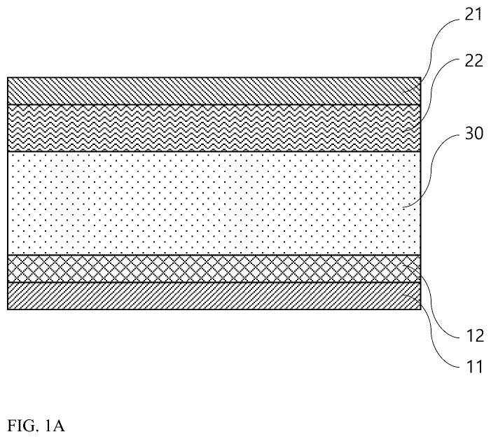

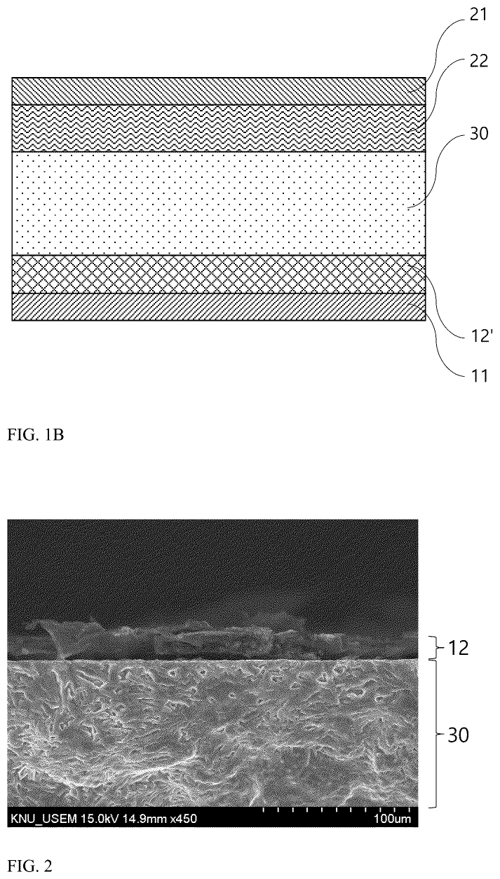

FIG. 1A and FIG. 1B schematically showing an all-solid-state battery according to an exemplary embodiment of the present disclosure in a discharged state and a charged state, respectively. Referring to these figures, the all-solid-state battery in the discharged state may include an anode current collector 11, a coating layer 12 located on the anode current collector 11 and including a layered carbon material, a solid electrolyte layer 30 located on the coating layer 12, a cathode active material layer 22 located on the solid electrolyte layer 30 and including a cathode active material configured to enable intercalation and deintercalation of lithium ions, and a cathode current collector 21 located on the cathode active material layer 22. Here, the layered carbon material may include at least one pore.

The anode current collector 11 may be a plate-shaped base having electrical conductivity. Concretely, the anode current collector 11 may be provided in a form of a sheet, a thin film, or foil. The anode current collector 11 may be a high-density metal thin film having porosity of less than about 1%. Furthermore, the anode current collector 11 may have a thickness of 1 μm to 20 μm, or 5 μm to 15 μm.

The anode current collector 11 may include a material which does not react with lithium. Concretely, the anode current collector 11 may include at least one selected from the group consisting of Ni, Cu, stainless steel (SUS), and combinations thereof.

The layered carbon material included in the coating layer 12 may include pores between one carbon material layer and another carbon material layer adjacent thereto. According to an exemplary embodiment of the present disclosure, the average pore size, total pore volume and BET surface area of the coating layer 12 using the layered carbon material may be increased compared to use of a spherical carbon material. Accordingly, a large amount of lithium may be stored.

The solid electrolyte layer 30 is located between the coating layer 12 and the cathode active material layer 22, and is in charge of migration of lithium ions.

The solid electrolyte layer 30 may include a solid electrolyte having lithium ion conductivity.

The solid electrolyte may include at least one selected from the group consisting of an oxide-based solid electrolyte, a sulfide-based solid electrolyte, a polymer electrolyte, and combinations thereof. Preferably, a sulfide-based solid electrolyte having high lithium ion conductivity may be used.

The sulfide-based solid electrolyte may have an argyrodite-type crystal structure. The sulfide-based solid electrolyte having the argyrodite-type crystal structure may be expressed as Li₆PS₅X (x being Cl, Br or I), and may include at least one selected from the group consisting of Li₆PS₅Cl, Li₆PS₅Br, Li₆PS₅I, and combinations thereof.

The sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like, without being limited to a specific material.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The polymer electrolyte may include a gel polymer electrolyte, a solid polymer electrolyte, or the like.

The solid electrolyte layer 30 may further include a binder. The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

The cathode current collector 21 may be a plate-shaped base having electrical conductivity. Concretely, the cathode current collector 21 may be provided in a form of a sheet or a thin film. The cathode current collector 21 may include at least one selected from the group consisting of indium (In), copper (Cu), magnesium (Mg), aluminum (Al), stainless steel, iron, and combinations thereof. Concretely, the cathode current collector 21 may include aluminum foil.

The cathode active material layer 22 may be configured to reversibly intercalate and deintercalate lithium ions thereinto and therefrom, and may include a cathode active material, a conductive material, a binder, and the like. Furthermore, a solid electrolyte may be partially mixed with the cathode active material layer 22.

The cathode active material may be an oxide active material or a sulfide active material.

The oxide active material may be a rocksalt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rocksalt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), or lithium titanate, such as Li₄Ti₅O₁₂.

The sulfide active material may be copper Chevrel, iron sulfide, cobalt sulfide, nickel sulfide, or the like.

The solid electrolyte mixed with the cathode active material layer 22 may be substantially the same as the solid electrolyte included in the solid electrolyte layer 30.

The conductive material may be carbon black, conductive graphite, ethylene black, carbon fibers, graphene, or the like.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), or the like.

In an exemplary embodiment of the present disclosure, the layered carbon material may include at least one selected from the group consisting of graphene, graphene oxide, reduced graphene oxide, carbon nanotubes (CNTs), and combinations thereof.

Graphene is a material in which carbon atoms are located at vertices of a hexagonal lattice to form a two-dimensional plane, and is a representative layered carbon material. The carbon nanotubes (CNTs) are tubes formed by rolling up graphene to include a nano-scaled diameter, i.e., a diameter of several to tens of nanometers. The carbon nanotubes (CNTs) may be divided into single-walled carbon nanotubes, double-walled carbon nanotubes, multi-walled carbon nanotubes, and carbon nanotube ropes, depending on the number of walls of carbon nanotubes.

Referring to FIG. 1B, when the all-solid-state battery is charged, lithium ions may be stored in a form of lithium metal in the pores of the coating layer 12′.

When the all-solid-state battery is charged, lithium ions are deintercalated from the cathode active material layer 22, and the lithium ions may migrate toward the anode current collector 11 via the solid electrolyte layer 30. The lithium ions reaching the coating layer 12′ may migrate to the inside of the coating layer 12′ through diffusion. Concretely, the diffusion may be diffusion creep.

Creep indicates continuation of deformation of a specific material over time, in a situation in which stress of yield strength or less is applied to the material. Creep occurring due to diffusion while exchanging positions of atoms and pores in the material is referred to as diffusion creep.

Diffusion creep may be divided into Nabarro-Herring creep in which atoms move along the insides of grains, and Coble creep in which atoms move along boundaries, such as grain boundaries, interfaces, and surfaces.

A operating pressure of yield strength or less may be applied to the all-solid-state battery according to an exemplary embodiment of the present disclosure, during charging and discharging. Accordingly, lithium ions adjacent to the solid electrolyte layer 30 and the coating layer 12′ may move to the inside of the coating layer 12′ through diffusion creep. Diffusion of the lithium ions to the inside of the coating layer 12′ may be performed through Nabarro-Herring creep and Coble creep depending on the positions of the lithium ions.

The lithium ions may preferably move to the pores of the layered carbon material through Coble creep, and be stored in a form of lithium metal. Coble creep occurs at a low temperature compared to Nabarro-Herring creep, and may thus be advantageous for low-temperature driving of the all-solid-state battery.

In an exemplary embodiment of the present disclosure, in the charged state of the all-solid-state battery, the coating layer 12′ may not include sulfur (S), and may include at least one selected from the group consisting of bromine (Br), chlorine (Cl), iodine (I), and combinations thereof.

Concretely, the upper portion of the coating layer 12′ adjacent to the solid electrolyte layer 30 may include lithium (Li); and at least one selected from the group consisting of bromine (Br), chlorine (Cl), iodine (I), and combinations thereof; and the lower portion of the coating layer 12′ adjacent to the anode current collector 11 may include carbon (C); lithium (Li); and at least one selected from the group consisting of bromine (Br), chlorine (Cl), iodine (I), and combinations thereof.

In the charged state of the all-solid-state battery, carbon (C) or lithium (Li) included in the coating layer 12′ may react with bromine (Br), chlorine (Cl), and iodine (I) to form a composite, but may not react with sulfur (S) so as not to form a composite.

In an exemplary embodiment of the present disclosure, the average diameter D50 of the pores may be 30.08 nm to 33.13 nm. When the average diameter D50 of the pores is less than 30.08 nm, a space in the coating layer 12 configured to receive and store lithium ions in a form of lithium metal may not be sufficient.

When the average diameter D50 of the pores exceeds 33.13 nm, the lithium ions may be deposited and stored between the coating layer 12 and the anode current collector 11 not in the coating layer 12. When the lithium ions are deposited between the coating layer 12 and the anode current collector 11, lithium may be non-uniformly deposited or lithium dendrites may be formed due to repetition of the charge and discharge cycle, and irreversible reaction gradually increases and may thus reduce the life characteristics of the all-solid-state battery.

In an exemplary embodiment of the present disclosure, the total pore volume of the coating layer 12 may be 0.114 cm³g⁻¹ or more. Concretely, the total pore volume of the coating layer 12 may be 0.114 cm³g⁻¹ to 0.141 cm³g⁻¹.

When the total pore volume of the coating layer 12 is less than 0.114 cm³g⁻¹, the space in the coating layer 12 configured to receive and store lithium ions in a form of lithium metal may not be sufficient, and thus, the capacity of the all-solid-state battery may be reduced.

Furthermore, lithium ions not stored in the coating layer 12 may be deposited between the coating layer 12 and the solid electrolyte layer 30, and thus, life characteristics of the all-solid-state battery may be reduced.

In an exemplary embodiment of the present disclosure, the BET surface area of the coating layer 12 may be 15.03 m²g⁻¹ or more. Concretely, the BET surface area of the coating layer 12 may be 15.03 m²g⁻¹ to 17.15 m²g⁻¹.

When the BET surface area of the coating layer 12 is less than 15.03 m²g⁻¹, the pores in the coating layer 12 configured to receive and store lithium ions in a form of lithium metal may not be sufficient, and thus, the capacity of the all-solid-state battery may be reduced.

Furthermore, lithium ions not stored in the coating layer 12 may be deposited between the coating layer 12 and the solid electrolyte layer 30, and thus, the life characteristics of the all-solid-state battery may be reduced.

In an exemplary embodiment of the present disclosure, in the discharged state of the all-solid-state battery, the thickness of the coating layer 12 may be 10 μm to 30 μm. When the thickness of the coating layer 12 is less than 10 μm in the discharged state of the all-solid-state battery, it is difficult to store a sufficient amount of lithium, and when the thickness of the coating layer 12 exceeds 30 μm in the discharged state of the all-solid-state battery, the energy density of the all-solid-state battery may be reduced.

In an exemplary embodiment of the present disclosure, a difference between the thickness of the coating layer 12′ in the charged state of the all-solid-state battery and the thickness of the coating layer 12 in the discharged state of the all-solid-state battery may be 5 μm or more. The upper limit of the difference between the thickness of the coating layer 12′ and the thickness of the coating layer 12 is not limited to a specific value, and for example, may be 30 μm or less, 20 μm or less, or 10 μm or less.

When the difference between the thickness of the coating layer 12′ in the charged state of the all-solid-state battery and the thickness of the coating layer 12 in the discharged state of the all-solid-state battery is less than 5 μm, it may be determined that a sufficient amount of lithium metal was not stored in the coating layer 12. Furthermore, it may be determined that lithium not stored in the coating layer 12 was deposited between the coating layer 12 and the anode current collector 11, or a separate lithium metal layer was formed between the coating layer 12 and the solid electrolyte layer 30.

Manufacturing Method of all-Solid-State Battery Having Coating Layer Including Layered Carbon Material

A manufacturing method of the all-solid-state battery according to an exemplary embodiment of the present disclosure may include preparing a structure in which the anode current collector 11, the coating layer 12, the solid electrolyte layer 30, the cathode active material layer 22 and the cathode current collector 21 are sequentially stacked, and pressing the structure.

Process pressure applied to press the structure may be greater than 50 MPa but less than 200 MPa. The process pressure may be preferably 85 MPa to 150 MPa, and may be more preferably about 100 MPa.

The manufacturing method of the all-solid-state battery is accompanied by a process of bonding an anode, a solid electrolyte and a cathode by applying high pressure (referred to hereinafter as “process pressure”). In general, the process pressure of 500 MPa or more is applied to the stack structure. When the same process pressure as the conventionally applied process pressure is applied to the all-solid-state battery according to an exemplary embodiment of the present disclosure, the electrochemical characteristics and life characteristics of the all-solid-state battery may be reduced due to reduction of the pores included in the layered carbon material.

When the process pressure is 50 MPa or less, adhesive force between the solid electrolyte layer 30 and the coating layer 12 is reduced and interfacial resistance is increased, and thereby, the electrochemical characteristics and life characteristics of the all-solid-state battery may be reduced.

When the process pressure is in the range of 85 MPa to 150 MPa, the electrochemical characteristics and life characteristics of the all-solid-state battery may be improved, and particularly, when the process pressure is about 100 MPa, the electrochemical characteristics and life characteristics of the all-solid-state battery may be greatly improved.

Heat loss of electrical energy may occur during the charging and discharging process of the all-solid-state battery due to interfacial resistance between the respective layers of the all-solid-state battery. Thus, the all-solid-state battery should be charged and discharged at higher voltage than voltage which is thermodynamically calculated. A difference between voltage which is theoretically required and voltage which is actually required for driving is referred to as overpotential. The closer the overpotential is to zero, the smaller the difference between theoretical driving voltage and actual driving voltage of the all-solid-state battery is, and thus, efficiency of the all-solid-state battery may be increased.

When the process pressure is 50 MPa or less, interfacial resistance between the solid electrolyte layer 30 and the coating layer 12 may be increased, the overpotential may be raised, and efficiency of the all-solid-state battery may be reduced.

When the process pressure is 200 MPa or more, excessive pressure is applied to the coating layer 12, and thereby, the pore volume, pore size, and BET surface area of the coating layer 12 may be reduced. That is, pores formed in the coating layer 12 may not be sufficient. Thereby, the capacity of the all-solid-state battery may be reduced.

Hereinafter, the present disclosure will be described in more detail through the following Examples and Comparative Examples. The following Examples and Comparative Examples serve merely to exemplarily describe the present disclosure, and are not intended to limit the scope and spirit of the present disclosure.

### Manufacturing Example 1. Manufacture of Anode

Slurry was manufactured by putting graphene prepared as a layered carbon material and polyvinylidene fluoride (PVDF) as a binder into a N-methyl-2-pyrrolidone (NMP) as a solvent. A coating layer 12 was formed by applying the slurry to a nickel thin film as an anode current collector and drying the slurry. An anode including the anode current collector and the coating layer 12 was acquired by the above method.

### Manufacturing Example 2. Manufacture of Solid Electrolyte

Raw materials were prepared by mixing lithium sulfide (Li₂S) powder (produced by Sigma-Aldrich), phosphorus pentasulfide (P₂S₅) powder (produced by Sigma-Aldrich), lithium chloride (LiCl) powder (produced by Sigma-Aldrich), and lithium bromide (LiBr) powder. A precursor solution was prepared by dissolving the raw materials in acetonitrile as a solvent. The precursor solution was stirred at room temperature (25° C.) until all the raw materials were dissolved in the solvent.

The solvent was completely removed by vacuum-drying the precursor solution at a temperature of about 200° C. for about 12 hours. Accordingly, precursor powder was acquired. A sulfide-based solid electrolyte having an argyrodite-type crystal structure including Br and Cl was acquired by heat-treating the precursor powder at a temperature of about 550° C. for about 5 hours.

### Example 1

A half-cell including the anode manufactured according to Manufacturing Example 1 and the solid electrolyte manufactured according to Manufacturing Example 2 was manufactured. A manufacturing method of the half-cell is as follows.

A solid electrolyte layer formed of the sulfide-based solid electrolyte according to Manufacturing Example 2 and having a designated size and thickness was manufactured.

The anode according to Manufacturing Example 1 was placed on one surface of the solid electrolyte layer, and was pressed against the surface of the solid electrolyte layer by applying process pressure of 100 MPa thereto. The half-cell was manufactured by adhering lithium foil (produced by Honjo Chemical Corporation) having a thickness of 200 μm to the other surface of the solid electrolyte layer. Operating pressure of 5 MPa was applied to the half-cell by a spring.

### Comparative Example 1

A half-cell was manufactured in the same manner as in Example 1 except that the process pressure applied to the solid electrolyte and the anode was adjusted to 50 MPa.

### Comparative Example 2

A half-cell was manufactured in the same manner as in Example 1 except that the process pressure applied to the solid electrolyte and the anode was adjusted to 200 MPa.

### Comparative Example 3

A half-cell was manufactured in the same manner as in Example 1 except that the process pressure applied to the solid electrolyte and the anode was adjusted to 400 MPa.

### Test Example 1: SEM Analysis Before Charging

FIG. 2 is a scanning electron microscopy (SEM) image of the half-cell manufactured according to Example 1, in a state in which the half-cell is not charged. Before SEM, the anode current collector was removed.

Referring to FIG. 2, the coating layer 12 including the layered carbon material was formed on the solid electrolyte layer 30, and the thickness of the coating layer 12 was about 10 μm.

### Test Example 2: Voltage Profile and Life Characteristics

Voltage profiles and life characteristics of the half-cells manufactured according to Example 1 and Comparative Examples 1 to 3 were evaluated while repeating the charge and discharge cycle under predetermined conditions, i.e., an operating temperature of 30° C., a current density of 0.666 mA·cm⁻², and a deposition capacity of 2.0 mAh·cm⁻².

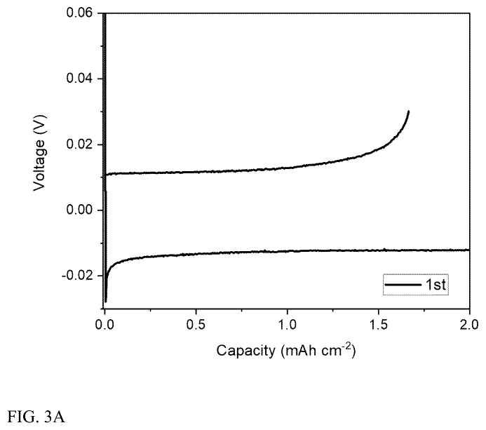

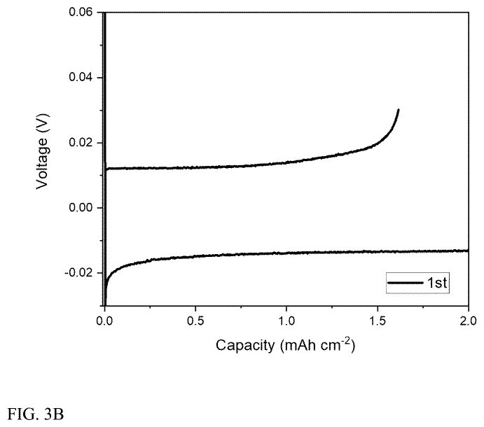

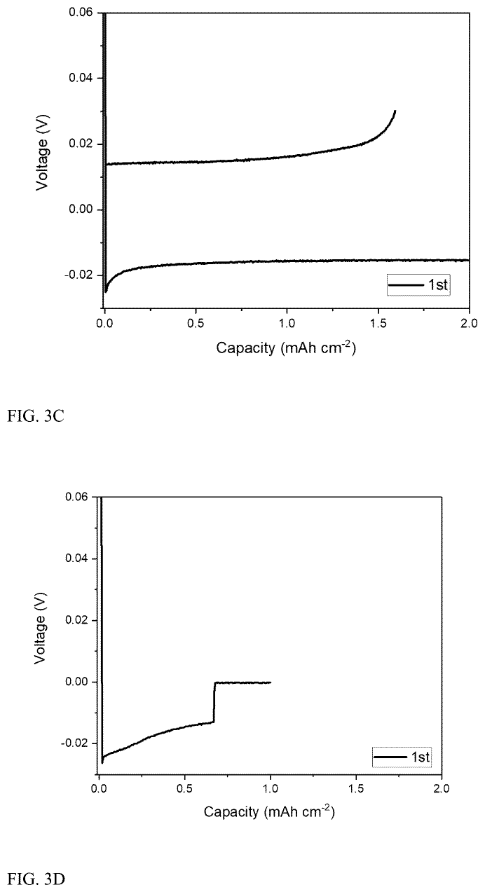

FIG. 3A is a graph showing a voltage profile of the half-cell manufactured according to Example 1 in the first cycle. FIG. 3B, FIG. 3C, and FIG. 3D are graphs showing voltage profiles of the half-cells manufactured according to Comparative Examples 1 to 3 in the first cycle.

Referring to FIG. 3A, FIG. 3B, FIG. 3C, and FIG. 3D, the half-cell manufactured by applying a process pressure of 100 MPa according to Example 1 exhibited the lowest overpotential.

Furthermore, normal measurement of the overpotential of the half-cell manufactured by applying a process pressure of 400 MPa according to Example 3 was impossible due to short-circuit.

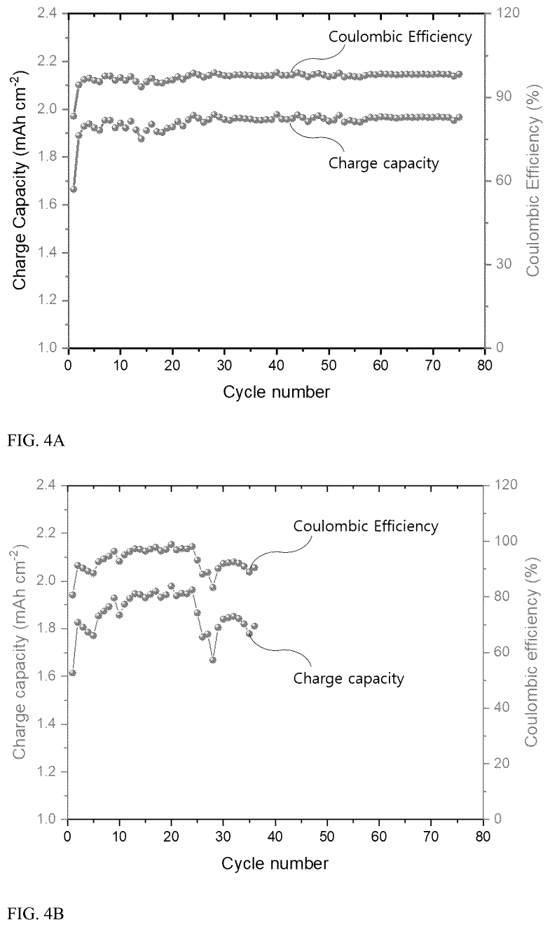

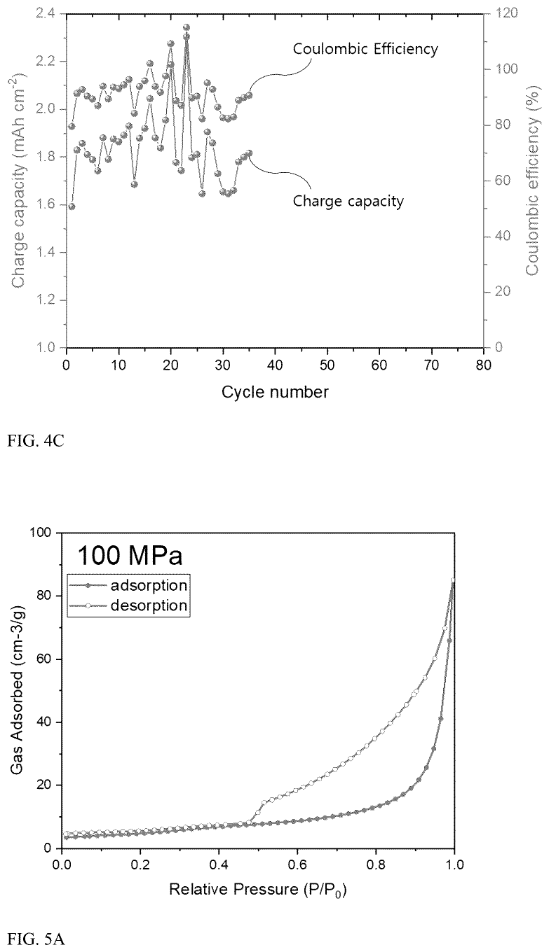

FIG. 4A is a graph showing changes in Coulombic efficiency and capacity of the half-cell manufactured according to an exemplary embodiment of the present disclosure depending on repetition of the charge and discharge cycle. FIG. 4B and FIG. 4C are graphs showing changes in Coulombic efficiencies and capacities of the half-cells manufactured according to Comparative Examples 1 and 2 depending on repetition of the charge and discharge cycle. In the case of the half-cell according to Comparative Example 3, repetition of the charge and discharge cycle was impossible due to short-circuit.

Referring to FIG. 4A, FIG. 4B and FIG. 4C, the half-cell manufactured by applying the process pressure of 100 MPa according to Example 1 exhibited uniform Coulombic efficiency and life characteristics, and the cycle life of the half-cell was 75 cycles.

The Coulombic efficiency and life characteristics of the half-cell manufactured according to Comparative Example 1 were drastically reduced from about the 20^{th} cycle, and the cycle life of the half-cell was 36 cycles. Deviations of the Coulombic efficiency and life characteristics of the half-cell manufactured according to Comparative Example 2 were observed from the beginning of the charge and discharge cycle, and the cycle life of the half-cell was 35 cycles.

### Test Example 3: Measurement of Porosity

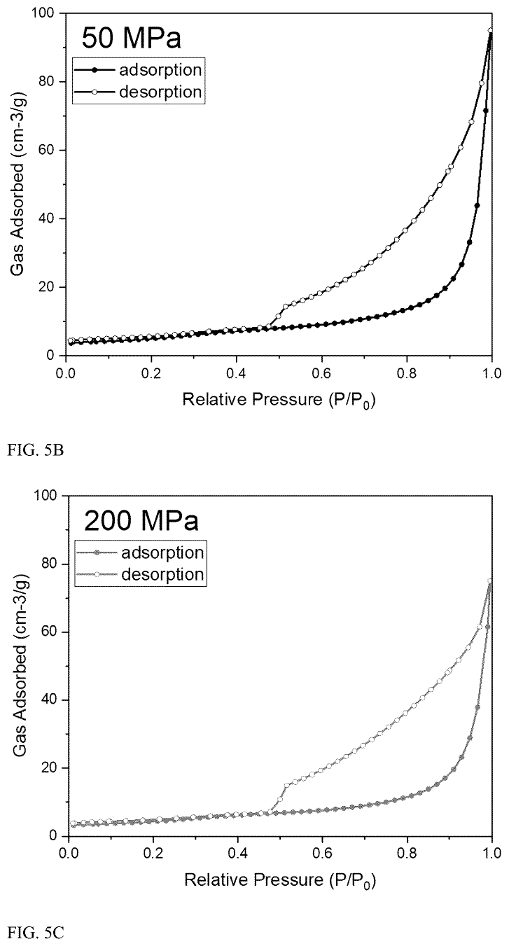

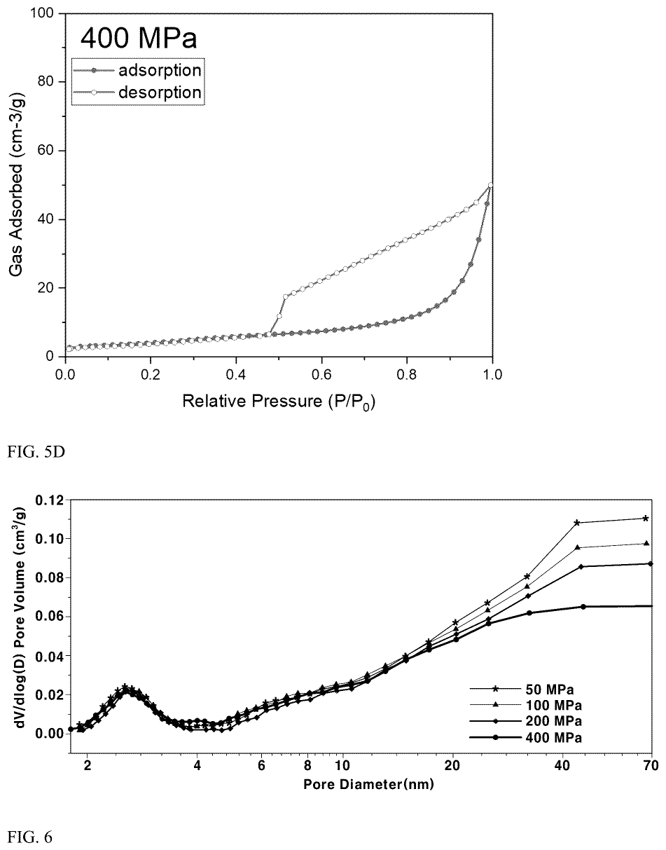

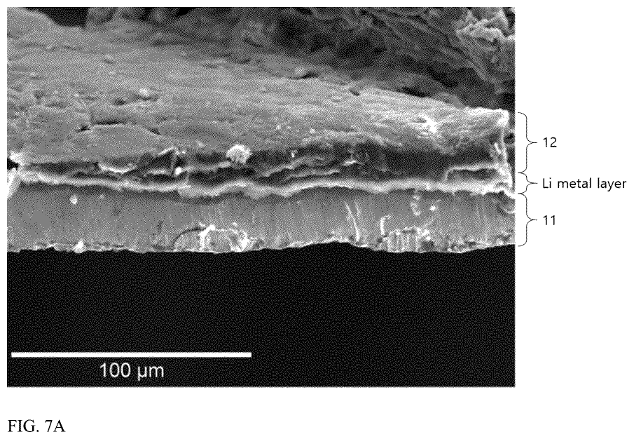

BET surface areas, total pore volumes and average pore sizes of the coating layers 12 included in the half-cells manufactured according to Example 1 and Comparative Examples 1 to 3 were analyzed, and are shown in FIG. 5A, FIG. 5B, FIG. 5C, and FIG. 5D and set forth in Table 1. FIG. 6 shows pore distributions of the half-cells manufactured according to Example 1 and Comparative Examples 1 to 3. Here, the BET surface areas, total pore volumes and average pore sizes were measured using the Brunauer-Emmett-Teller (BET) method, and the pore distributions were measured using Barrett-Joyner-Halenda (BJH) method.

TABLE 1

| | Comp. | | Comp. | Comp. |
|---|---|---|---|---|
| | Example 1 | Example 1 | Example 2 | Example 3 |
| BET surface | 17.16 | 16.46 | 15.02 | 14.44 |
| area | | | | |
| (m²g⁻¹) | | | | |
| Total pore | 0.141 | 0.128 | 0.114 | 0.0772 |
| volume | | | | |
| (cm³g⁻¹) | | | | |
| Average pore | 33.14 | 31.14 | 30.07 | 21.40 |
| size | | | | |
| (nm) | | | | |

As set forth in Table 1, it may be configured that, as the process pressure applied during the manufacturing process of the half-cells is increased, all the BET surfaces, total pore volumes and average pore sizes of the coating layers included in the half-cells are reduced.

Furthermore, referring to FIG. 6, it may be confirmed that, when the process pressure applied during the manufacturing process of the half-cells is increased, the ratio of pores having a size of less than 20 nm is uniform, but the ratio of pores having a size of 20 nm or more is reduced as the process pressure is increased.

### Test Example 5: SEM and EDS Measurement Results in Fully Charged State

SEM images and energy-dispersive X-ray spectroscopy (EDS) images of the half-cells manufactured according to Example 1 and Comparative Examples 1 to 3 were obtained to confirm stored positions of lithium depending on pressing conditions. Here, the SEM images and EDS images were obtained by tilting side parts of the respective electrodes at a designated angle.

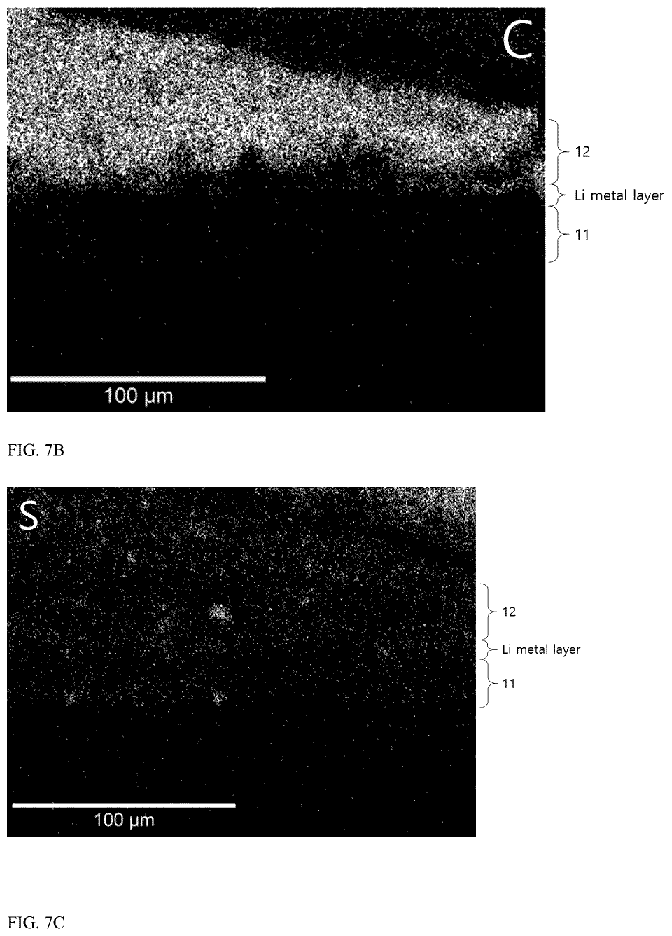

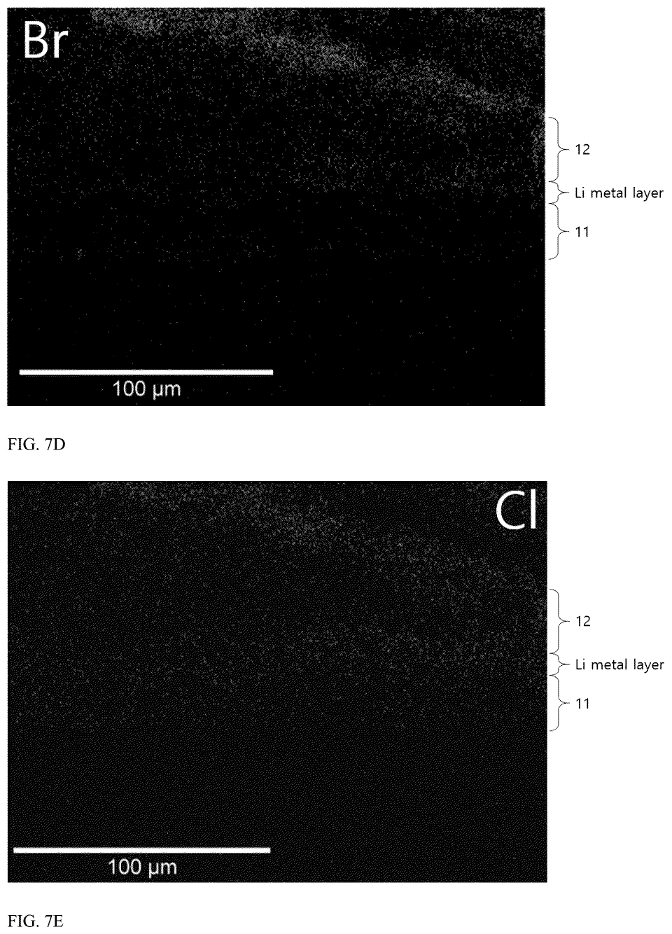

FIG. 7A is the SEM image of the half-cell manufactured according to Comparative Example 1. FIGS. 7B to 7E are EDS images of carbon (C), sulfur (S), bromine (Br) and chloride (Cl) included in the half-cell manufactured according to Comparative Example 1, respectively. Here, the images were obtained after the solid electrolyte layer 30 located on the coating layer 12 was removed.

Referring to FIG. 7A, the coating layer 12 having a thickness of about 10 μm and a lithium metal layer having a thickness of about 8 μm were confirmed, and the lithium metal layer was observed as being located between the anode current collector 11 and the coating layer 12. Bromine (Br) and chloride (Cl) were detected from the lithium metal layer. It is predicted that formation of the lithium metal layer between the coating layer 12 and the anode current collector 11 rather than in the coating layer 12, as shown in FIGS. 7A to 7E, was caused by ease in penetration of lithium into the coating layer 12 having high porosity due to manufacture of the half-cell according to Comparative Example 1 under relatively low pressure conditions.

Furthermore, it is predicted that detection of sulfur (S) on the surface of the coating layer 12 was caused by sulfur (S) remaining on the surface of the coating layer 12 after removing the solid electrolyte layer 30 therefrom.

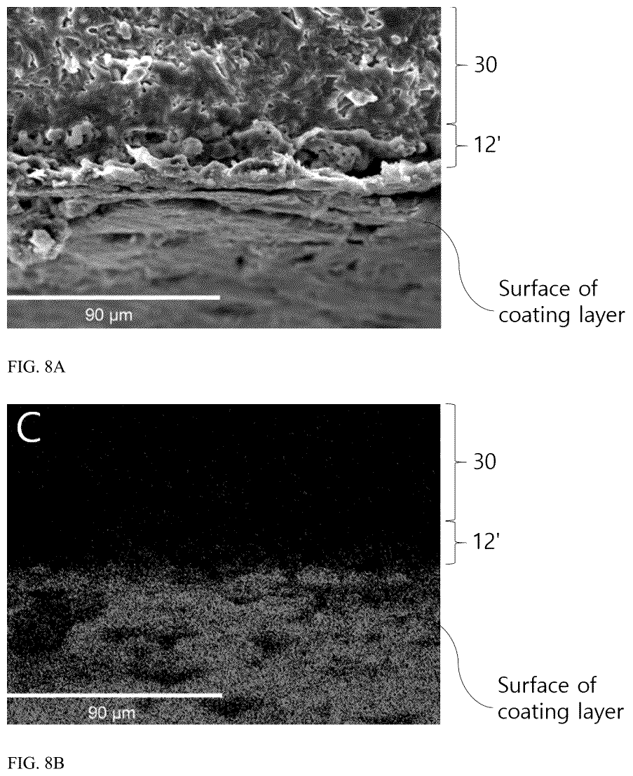

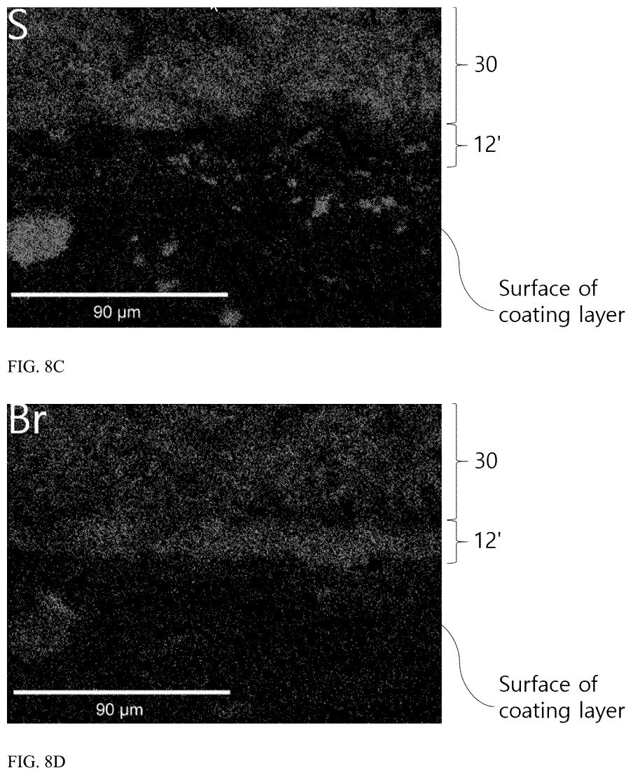

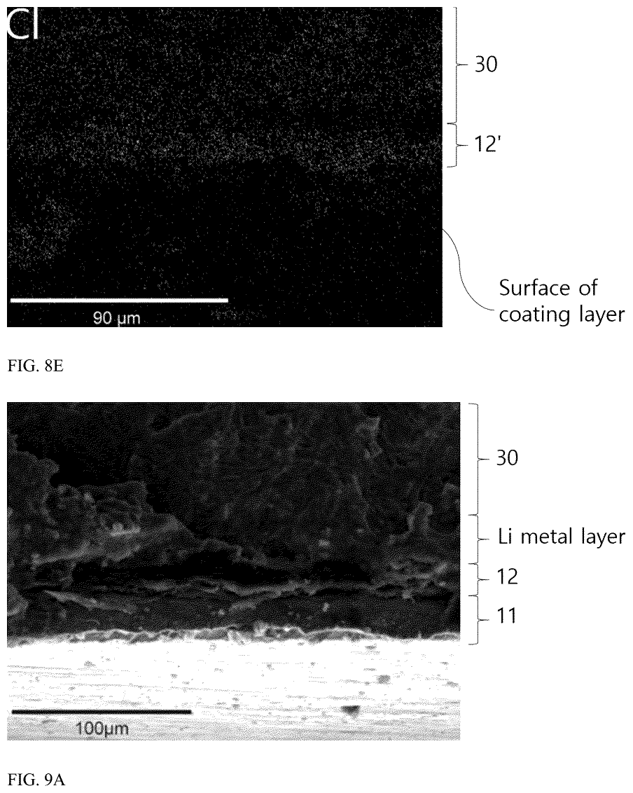

FIG. 8A is the SEM image of the half-cell manufactured according to Example 1. FIGS. 8B to 8E are EDS images of carbon (C), sulfur (S), bromine (Br) and chloride (Cl) included in the half-cell manufactured according to Example 1, respectively. Here, the SEM and EDS images were obtained after the anode current collector was removed.

Referring to FIG. 8A, the coating layer 12′ having a thickness of about 20 μm was confirmed, and the separate lithium metal layer shown in FIG. 7A distinguished from the coating layer 12′ was not observed. It may be confirmed that lithium was uniformly stored in the coating layer 12′, in the way that bromine (Br) and chloride (Cl) were detected from the coating layer 12′ but sulfur (S) was not detected therefrom.

These results are caused by the fact that lithium included in the coating layer 12′ reacts with bromine (Br) and chlorine (Cl) to form a composite, but does not react with sulfur (S) so as not to form a composite.

Furthermore, bromine (Br) and chloride (Cl) were observed but carbon (C) and sulfur (S) was not observed in the upper portion of the coating layer 12′ located adjacent to the solid electrolyte layer 30, and carbon (C), bromine (Br) and chloride (Cl) were observed but only sulfur (S) was not observed on the surface of the coating layer 12′ (i.e., in the lower portion of the coating layer 12′) located adjacent to the anode current collector 11.

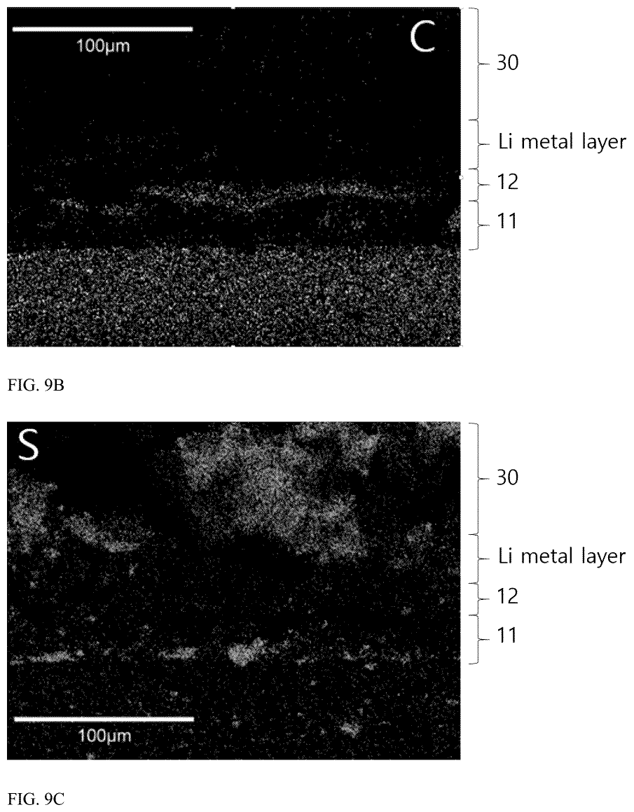

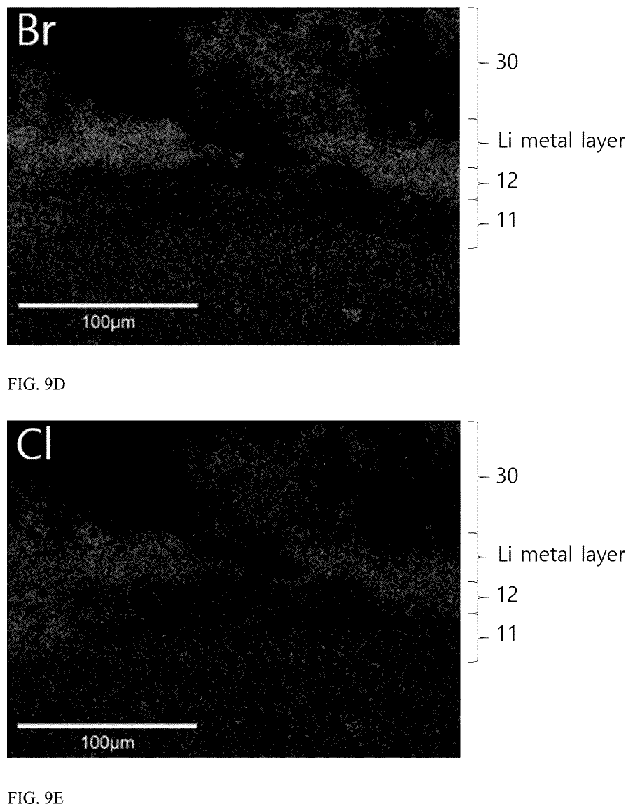

FIG. 9A is the SEM image of the half-cell manufactured according to Comparative Example 2. FIGS. 9B to 9E are EDS images of carbon (C), sulfur (S), bromine (Br) and chloride (Cl) included in the half-cell manufactured according to Comparative Example 2, respectively.

Referring to FIG. 9A, the coating layer 12 having a thickness of about 14 μm and a lithium metal layer having a thickness of about 25 μm provided separately from the coating layer 12 were confirmed, and the lithium metal layer was observed as being located between the coating layer 12 and the solid electrolyte layer 30. Bromine (Br) and chloride (Cl) were detected from the lithium metal layer, but sulfur (S) was not detected from the lithium metal layer. Furthermore, it may be confirmed that bromine (Br) and chloride (Cl) were not detected from the coating layer 12.

It is predicted that formation of the lithium metal layer between the coating layer 12 and the solid electrolyte layer 30 rather than in the coating layer 12, as shown in FIGS. 9A to 9E, was caused by difficulty in penetration of lithium into the coating layer 12 having low porosity due to manufacture of the half-cell according to Comparative Example 2 under relatively high pressure conditions.

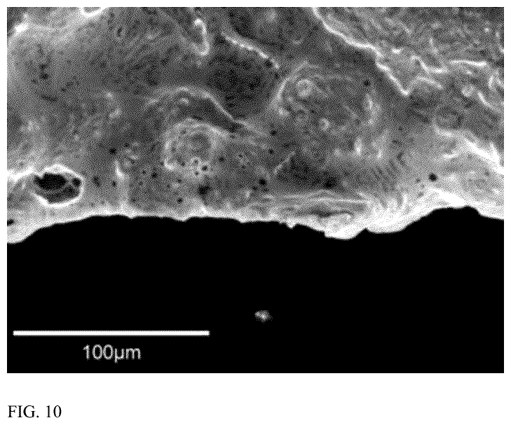

FIG. 10 is an SEM image of the half-cell manufactured according to Comparative Example 3. Here, the SEM image was obtained after the anode current collector was removed.

Referring to FIG. 10, the coating layer was completely combined with the solid electrolyte layer, and thus it was difficult to observe the coating layer separately from the solid electrolyte layer, and only the boundary of the coating layer buried in the electrolyte layer was observed in the SEM image.

As is apparent from the above description, the present disclosure provides an all-solid-state battery having improved life characteristics through a coating layer including a layered carbon material including at least one pore.

Furthermore, the all-solid-state battery is manufactured by pressing an anode, a solid electrolyte and a cathode within a pressure range which is greater than 50 MPa but less than 200 MPa, being capable of having improved life characteristics and reducing overpotential during the charging and discharging process of the all-solid-state battery.

In the present specification, unless particularly stated otherwise, a singular expression includes a plural expression unless the context clearly indicates otherwise.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An all-solid-state battery comprising:
an anode current collector;
a coating layer located on the anode current collector and comprising a layered carbon material;
a solid electrolyte layer located on the coating layer;
a cathode active material layer located on the solid electrolyte layer and comprising a cathode active material configured to enable intercalation and deintercalation of lithium ions; and
a cathode current collector located on the cathode active material layer,
wherein the layered carbon material comprises at least one pore.

2. The all-solid-state battery of claim 1, wherein the layered carbon material comprises at least one selected from the group consisting of graphene, graphene oxide, reduced graphene oxide, carbon nanotubes, and combinations thereof.

3. The all-solid-state battery of claim 1, wherein the lithium ions are stored in a form of lithium metal in the at least one pore of the coating layer in a state that the all-solid-state battery is charged.

4. The all-solid-state battery of claim 1, wherein an average diameter D50 of the at least one pore is 30.08 nm to 33.13 nm.

5. The all-solid-state battery of claim 1, wherein a total pore volume of the coating layer is 0.114 cm³g⁻¹ to 0.141 cm³g⁻¹.

6. The all-solid-state battery of claim 1, wherein a Brunauer-Emmett-Teller (BET) surface area of the coating layer is 15.03 m²g⁻¹ to 17.15 m²g⁻¹.

7. The all-solid-state battery of claim 1, wherein a difference between a thickness of the coating layer in a charged state of the all-solid-state battery and a thickness of the coating layer in a discharged state of the all-solid-state battery is equal to or more than 5 μm.

8. The all-solid-state battery of claim 1, wherein, in a charged state of the all-solid-state battery, the coating layer does not comprise sulfur (S), but comprises at least one selected from the group consisting of bromine (Br), chlorine (Cl), iodine (I), and combinations thereof.

9. The all-solid-state battery of claim 8,
wherein an upper portion of the coating layer adjacent to the solid electrolyte layer comprises lithium (Li), and at least one selected from the group consisting of bromine (Br), chlorine (Cl), iodine (I), and combinations thereof, and
wherein a lower portion of the coating layer adjacent to the anode current collector comprises carbon (C), lithium (Li), and at least one selected from the group consisting of bromine (Br), chlorine (Cl), iodine (I), and combinations thereof;

10. A method of manufacturing an all-solid-state battery, the method comprising:
preparing a structure configured so that an anode current collector, a coating layer, a solid electrolyte layer, a cathode active material layer and a cathode current collector are sequentially stacked; and
applying a process pressure of greater than 50 MPa but less than 200 MPa to the structure,
wherein the coating layer comprises a layered carbon material comprising at least one pore.

11. The method of claim 10, wherein the process pressure of 85 MPa to 150 MPa is applied to the structure.

12. The method of claim 10, wherein the layered carbon material comprises at least one selected from the group consisting of graphene, graphene oxide, reduced graphene oxide, carbon nanotubes, and combinations thereof.

13. The method of claim 10, wherein lithium ions are stored in a form of lithium metal in the at least one pore of the coating layer in a state that the all-solid-state battery is charged.

14. The method of claim 10, wherein an average diameter D50 of the at least one pore is 30.08 nm to 33.13 nm.

15. The method of claim 10, wherein a total pore volume of the coating layer is 0.114 cm³g⁻¹ to 0.141 cm³g⁻¹.

16. The method of claim 10, wherein a BET surface area of the coating layer is 15.03 m²g⁻¹ to 17.15 m²g⁻¹.

17. The method of claim 10, wherein a difference between a thickness of the coating layer in a charged state of the all-solid-state battery and a thickness of the coating layer in a discharged state of the all-solid-state battery is equal to or more than 5 μm.

18. The method of claim 10, wherein, in a charged state of the all-solid-state battery, the coating layer does not comprise sulfur (S), but comprises at least one selected from the group consisting of bromine (Br), chlorine (Cl), iodine (I), and combinations thereof.

19. The method of claim 18,
wherein an upper portion of the coating layer adjacent to the solid electrolyte layer comprises lithium (Li), and at least one selected from the group consisting of bromine (Br), chlorine (Cl), iodine (I), and combinations thereof; and
wherein a lower portion of the coating layer adjacent to the anode current collector comprises carbon (C), lithium (Li), and at least one selected from the group consisting of bromine (Br), chlorine (Cl), iodine (I), and combinations thereof;
